(19) United States
(12) Patent Application Publication
(10) Pub. No.: US 2007/0214974 A1
(43) Pub. Date: Sep. 20, 2007

(54) Transfer printer for cups and the like

(76) Inventors: Duke W. Goss, Kirkland, WA (US); Dan Kenney, Kirkland, WA (US)

Correspondence Address: BARNARD INTELLECTUAL PROPERTY LAW, INC., P.O. BOX 58888, SEATTLE, WA, 98138-1888, US

(21) Appl. No.: 11/378,181

(22) Filed: Mar. 17, 2006

(51) Int. Cl. B41F 17/00

(52) U.S. Cl. 101/35

(57) ABSTRACT

A clamping member (16) is substantially in the form of a cylinder with a narrow strip removed. The clamping member (16) is lined with a resilient layer (136). A heating layer (138) is positioned between the clamping member (16) and the resilient layer (136). A cup (22) surrounded by a heat transfer (142) is positioned in the clamping member (16) when the clamping member (16) is in an open position. Then, the end portions (42, 44) of the clamping member (16) are moved together so that they will in turn move the clamping member (16) and its liner (136) into snug engagement with the outer surface of the cup (22). Then electrical energy is applied to the heating element layer (138) for causing a transfer of printing and/or design indicia from the transfer (142) to the outer surface of the cup (22). Swinging movement of a handle (18) between first and second positions operates a mechanism that opens and closes the clamping member (16).

### TECHNICAL FIELD

This invention relates to the use of transfers to print text and/or artwork onto cylindrical objects, e.g. cups. More particularly, it relates to a mechanism for pressing a heat transfer onto the side surface of a cylindrical object such as a cup or the like and applying heat for transferring printing and/or artwork from the transfer onto the object.

### BACKGROUND OF THE INVENTION

There is a need for an apparatus and a method for exerting an adjustable clamping force on a heat transfer that is wrapped onto a curved surface of an object such as a cup, while at the same time applying heat to the transfer to cause it to release the printing and/or artwork that it carries onto the surface of the article. There is a need for such an apparatus and method which is operated by a simple swinging motion of a handle, in a first direction, for clamping onto a generally cylindrical object, such as a cup, and a heat transfer that has been wrapped onto it, and in a second direction for releasing the object after the printing and/or artwork has been moved from the transfer onto the object. It is the principal object of the present invention to fill these needs by the provision of an apparatus and method which are simple and easy to use.

### BRIEF SUMMARY OF THE INVENTION

The heat transfer printer of the present invention is basically characterized by a thin wall clamping member that is adapted to substantially surround a generally cylindrical object. The clamping member has spaced opposite end portions. Push-pull elements are connected to the opposite end portions of the clamping member and are operable for moving the end portions towards and away from each other. The clamping member has an inner surface and a heating element adjacent the inner surface. The generally cylindrical object to receive printing is placed within the clamping member, with a heat activated transfer positioned between it and the clamping member. Then, the opposite end portions of the clamping member are moved relatively together to contract the clamping member and cause it to press the heat transfer against the outer surface of the generally cylindrical object. After clamping, electrical energy is applied to the heating element for heating the transfer. The heat and the clamping pressure cause the text and/or design on the transfer to be deposited onto the outer surface of the generally cylindrical object.

According to an aspect of the invention, a resilient liner is carried by the clamping member inwardly of the heating element. The resilient liner is adapted to contact the transfer that is in contact with the outer surface of the cylindrical object that is to receive printing.

In preferred form, the opposite end portions of the clamping member form a gap between them. Also, the end portions of the clamping member are provided with stiffening members connected to the clamping member. The push-pull elements are connected to the stiffening members.

In preferred form, the push-pull elements are arcuate members having first and second ends. The first ends of the arcuate members are mounted for pivotal movement about an axis. The second ends are connected to the end portions of the clamping member. The arcuate members curve as they extend from their first ends to their second ends and are spaced outwardly from the clamping member.

The apparatus may include first and second control arms, each having a first end that is connected to intermediate portions of the arcuate members. The control arms are adapted to be retracted for swinging the second ends of the arcuate members apart, for pulling the end portions of the clamping member apart. The control arms are also adapted to be extended for swinging the arcuate members together, for pushing the end portions of the clamping member together and contracting the clamping member.

In preferred form, the first and second control arms include compression springs that are adapted to compress when the control arms are extended and expand when the control arms are retracted.

In the preferred embodiment, first push-pull elements are connected to the clamping member at a first location and second push-pull elements are connected to the clamping member at a second location spaced vertically from the first location. The push-pull members are arcuate members having first and second ends. The first ends of the arcuate members are mounted for pivotal movement about an axis. The second ends are connected to the end portions of the clamping member. The arcuate members curve as they extend from their first ends to their second ends and they are spaced radially outwardly from the clamping member. First and second control arms are provided. The control arms have first ends connected to intermediate portions of the arcuate members and are adapted to be retracted for swinging the second ends of the arcuate members apart and pulling the end portions of the clamping member apart, and are adapted to be extended for swinging the arcuate members together, for pushing the end portions of the clamping members together, and contracting the clamping member.

The end portions of the clamping member may be spaced apart at least the width of a cup handle so that the apparatus can be used for printing on a cup that includes a handle and the handle can be positioned between the opposite ends of the clamping member.

An object of the invention is to provide an apparatus of the type described that includes a control handle having a first position and a second position, and linkage between the handle and the push-pull elements. The handle and the linkage are adapted to extend the push-pull elements when the handle is swung from its first position to its second position, and to retract the push-pull elements when the handle is swung from its second position to its first position.

Other objects, advantages and features of the invention will become apparent from the description of the best mode set forth below, from the drawings, from the claims and from the principles that are embodied in the specific structures that are illustrated and described.

### BRIEF DESCRIPTION OF THE SEVERAL VIEWS OF THE DRAWINGS

Like reference numerals are used to designate like parts throughout the several views of the drawing, and:

FIG. 1 is a pictorial view of a cup printer embodying the present invention, such view showing a control handle in an up position, and showing the clamping member in an open position and a cup and a transfer in a spaced relationship to each other and to the clamping member;

FIG. 2 is a view like FIG. 1, but showing the cup and transfer down in the clamping member and showing an upper portion of the handle cut away;

FIG. 3 is a top plan view of the assembly shown by FIG. 2, with the handgrip portion of the handle cut away for the purpose of illustrating the components below it, and with the cup and transfer shown in broken or phantom line;

FIG. 4 is a view like FIG. 3, but showing the handle swung forwardly into a position in which linkage between the handle and the push-pull elements extend the push-pull elements and move the clamping member into a clamping position on the cup;

FIG. 5 is a fragmentary sectional view taken substantially along line 5-5 of FIG. 4, such view showing upper portions of the clamping member, the resilient liner and the heating element in section;

FIG. 6 is a view like FIG. 5 taken substantially along line 6-6 of FIG. 4, showing lower portions of the clamping member, the resilient liner and the heating element;

FIG. 7 is an enlarged scale, fragmentary side elevational view of the mechanism for opening and closing the clamp, such view showing the control handle in a somewhat upright position;

FIG. 8 is a view like FIG. 7, but showing the handle swung downwardly towards the clamp assembly;

FIG. 9 is a view like FIG. 7, but showing a portion of the adjustment screw assembly in section and another portion in side elevation;

FIG. 10 is a schematic view of the mechanism for converting rotary movement to linear movement, including a broken line showing of the control handle in the positions shown by FIG. 8;

FIG. 11 is view like FIG. 10, but including a broken line showing of the handle in the position shown by FIGS. 1 and 7; and

FIG. 12 is a fragmentary plan view of one of the control arms, with some elements in the view being shown in section.

### DETAILED DESCRIPTION OF THE ILLUSTRATED EMBODIMENT

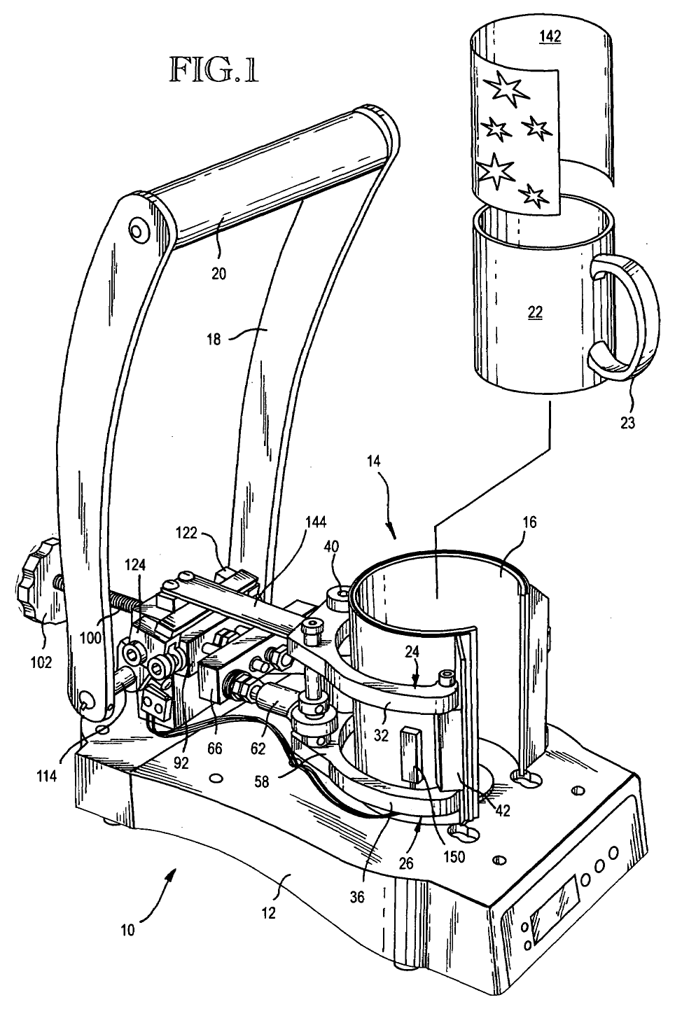

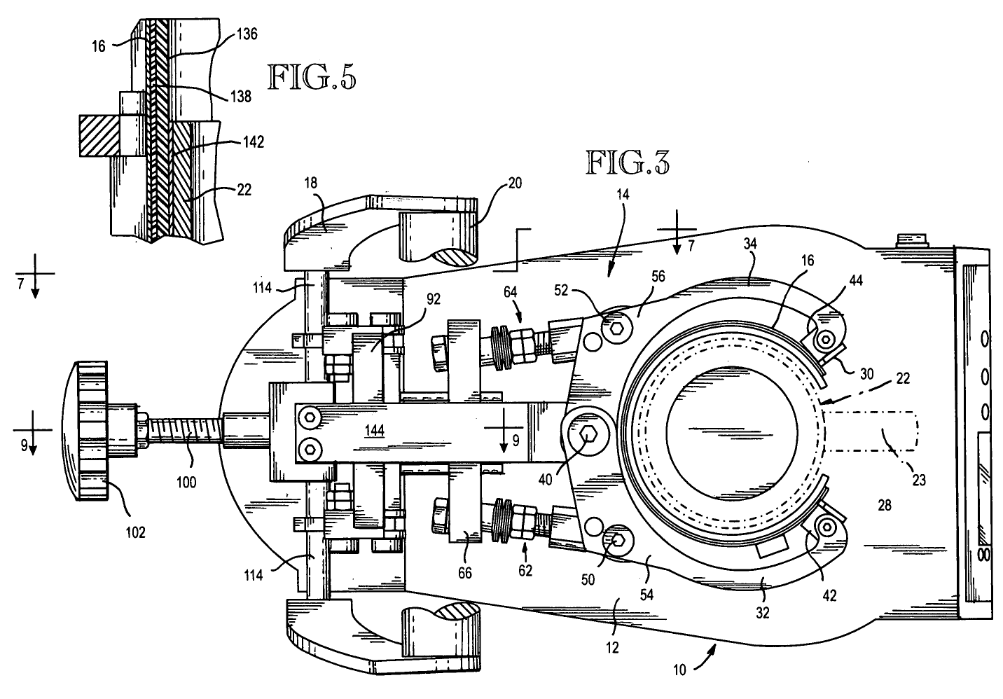

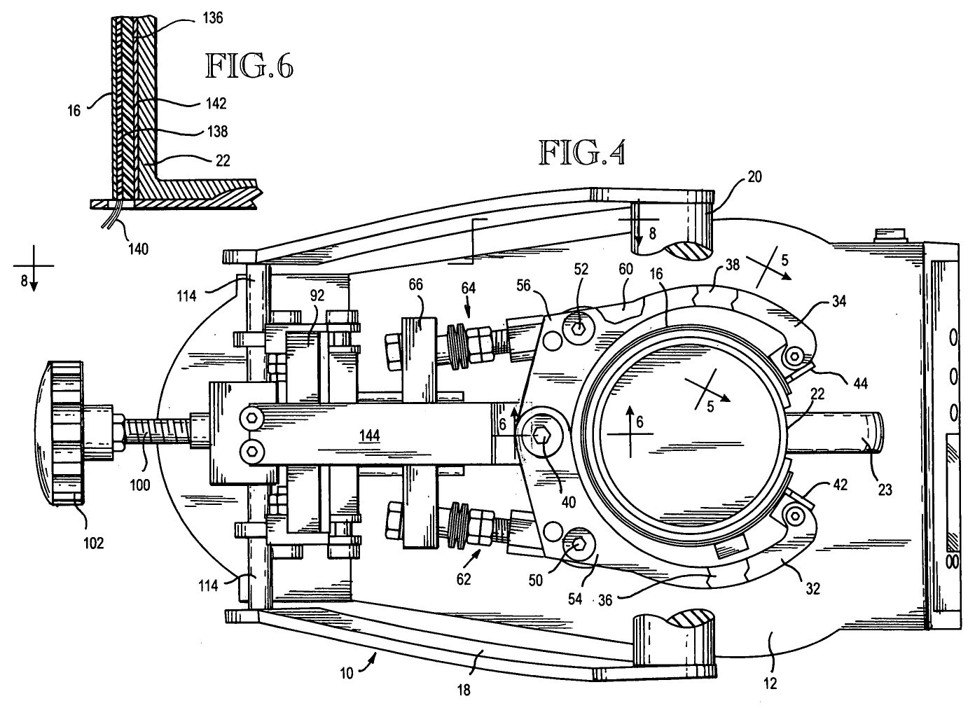

The illustrated transfer printer 10 comprises a base 12 supporting a clamping assembly 14 that includes a thin wall clamping member 16 and a control handle 18 having a handgrip portion 20. As will hereinafter be described in greater detail, the handle 18, 20 has a first position (“down”) in which it is forward and down (FIG. 4) and a second position (“up”) in which it is rearwardly and up (FIGS. 1 and 3). As will hereinafter be explained, movement of the handle 18, 20 opens and closes the clamping member 16.

The thin wall clamping member 16 is a major segment of a cylinder. It is constructed to substantially surround the cylindrical body portion of an object such as a cup 22. The mechanism 14 comprises upper and lower push-pull elements 24, 26 connected to end portions of the clamping member 16. In the illustrated embodiment, vertical stiffening members 28, 30 are connected to the end portions of the clamping member 16. As best shown by FIGS. 3 and 4, members 28, 30 extend generally radially outwardly from the clamping member 16. The push-pull members 24, 26 comprise an upper pair of arms 32, 34 and a lower pair of arms 36, 38. Arms 32, 34, 36, 38 are arcuate and have first and second ends. The first ends are mounted for pivotal movement about a vertical axis 40 established by a pin 40. The opposite or second ends of the arms 32, 34, 36, 38 are connected to the stiffeners 28, 30 by knuckle hinge members 42, 44. Specifically, vertical pivot pins extend downwardly through the end portions of the arms 24, 26, 28, 30 and into and through the knuckle hinge members 42, 44. When the arms 32, 34, 36, 38 are extended, the outer end portions of the clamping member 16 are pushed relatively together and the clamping member 60 is caused to snuggly surround and clamp onto the object 22. When the arms 32, 34, 36, 38 are retracted, the end portions of the clamping member 16 are pulled relatively apart and the clamping member 16 is moved away from the sidewall of the object 22, as shown in FIG. 4. At all times, there is a space outwardly of the clamping member 16, between it and the arms 32, 34, 36, 38. In this embodiment, the clamping member is controlled solely by movement of its outer end portions.

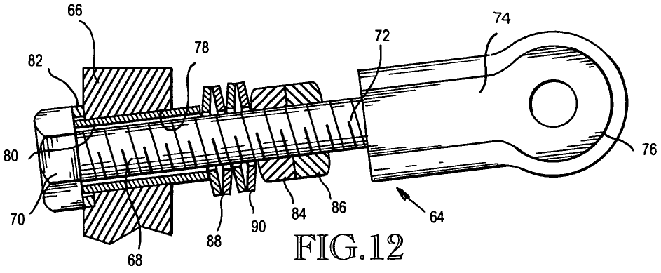

The arms 32, 34, 36, 38 have inner end portions that are pivotally connected by the pivot pin 40 for pivotal movement about the axis of pin 40. Vertical rods 50, 52 vertically interconnect intermediate portions 54, 56, 58, 60 (FIG. 4) of the arms 32, 34, 36, 38. As best shown by FIGS. 3 and 4, a pair of control arms 62, 64 extend between a transverse support member 66 and the vertical rods 50, 52. An example construction of the control arms 62, 64 is shown by FIG. 12 which is specific to control arm 64. The control arms 62, 64 each have a bolt 68 at one end which includes a bolt head 70. The opposite end 72 is threaded and it screws into an eye nut 74 that has an eye 76 at its outer end. An opening 78 is formed in the support member 66. A sleeve 80 is positioned in the opening 76. A washer 82 is positioned between the bolt head 70 and the support member 66 and the adjacent end of sleeve 80 contacts washer 82. Nuts 84, 86 are threaded onto end portion 72. Springs, shown in the form of bellevue washers 88, 90, are located between the nut 84 and the near end of the sleeve 80. As should be apparent, the springs 88, 90 allow some movement of the control arms 64 endwise towards the support member 66.

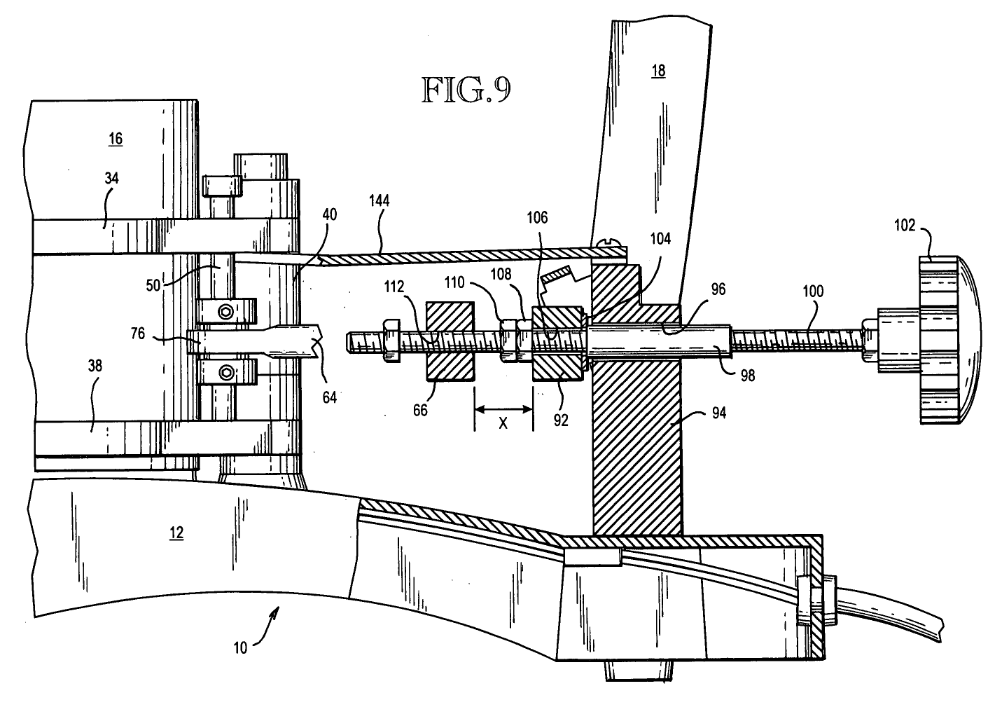

As best shown by FIG. 9, a second transverse support member 92 is positioned between the first transverse support member 66 and a standard 94. An opening 96 is formed in the standard 94. A nut 98 is positioned within the opening 96. Nut 98 is screwed onto an adjustment screw 100 having a control knob 102 at its outer end. The end of nut 98 opposite the knob 102 makes contact with a washer 104 that is positioned between such end of nut 98 and the support member 92. The adjustment screw 100 extends through an opening 104 in support member 102 and receives a pair of nuts 106, 108 that bear against the side of support member 92 opposite the washer 104. When the nuts 98, 106, 108 are tightened, the support member 92 and the washer 104 are firmly clamped between the nut 98 and nut 106. The opening 106 is not threaded and is larger in diameter than the outside diameter of the screw 100. As a result, when screw 100 is rotated, it rotates within the opening 106. A threaded opening 112 is provided in support member 66. The threads in the opening 112 engage the threads on the adjustment screw 100. When adjustment screw 100 is rotated in one direction, the support members 66 moves to the left of the position shown by FIG. 9. When the adjustment screw 100 is rotated in the opposite direction the support member 66 moves to the right as illustrated in FIG. 9. Thus, the adjustment screw 100 changes the spacing X of support member 92 from support member 66. Referring to FIGS. 3, and 4, movement of support member 66 to the left, as illustrated, imposes a pulling force on the control arms 62, 64. Control arms 62, 64 in turn apply a pulling force on the vertical rods 50, 52. This swings the push-pull arms 32, 34 outwardly about the vertical axis of pins 50, 52 and moves the ends of the clamping member 16 outwardly from the position shown by FIG. 4 to the position shown by FIG. 3. Movement of the support member 66 to the right, as illustrated, pushes on the control arms 62, 64. This causes the push-pull elements 32, 34 to swing in position from the position shown by FIG. 3 to the position shown by FIG. 4. The adjustment screw 100 provides a way of initially adjusting the open position of the clamping member 16. It is moved between the open position and a closed position by a swinging movement of the handle 18, 20.

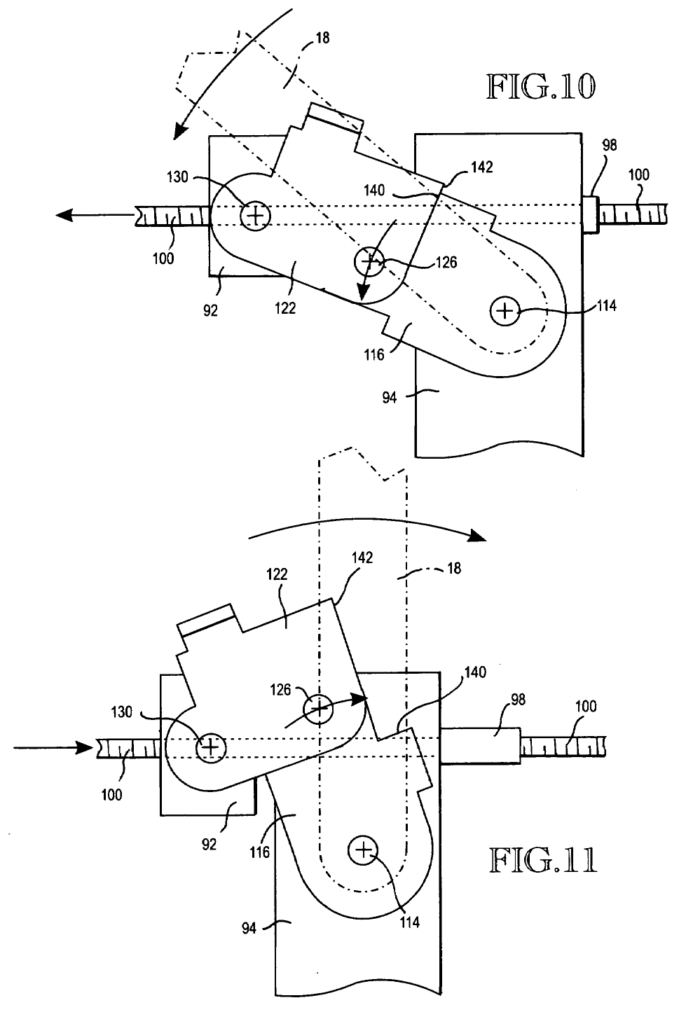

Referring to FIGS. 10 and 11, a transverse opening is formed in the standard 94. A live shaft 114 extends through this opening and has end portions that project outwardly from the ends of the transverse opening Crank arms 116, 118 are connected to the outer end portions of the live shaft 114. Outwardly of the crank arms 116, 118, the end portions of the live shaft 114 are connected to lower side portions 120, 122 of the handle 18. As will be further described, a swinging movement of the handle 18 will cause a rotation of the live shaft 114. This will swing the crank arms 116, 118 in position about the axis of the live shaft 114. FIG. 10 shows the handle 18 swung downwardly towards the clamping member 16. FIG. 11 shows the handle 18 swung into a generally upright position. Links 122, 124 are pivotally connected to the crank arms 116, 118 by pin connections 126. Opposite end portions of the links 122, 124 are pivotally connected to the transverse support member 92 by a pivot pin 130.

As a comparison of FIGS. 10 and 11 will show, when the crank arms 116, 118 are rotated by movement of handle 18 from the position shown by FIG. 10 to the position shown by FIG. 11, the links 122, 124 will swing in position and exert a pulling force on support member 92, moving it towards the standard 94. This particular movement of support member 92 by operation of the handle 18 causes a like amount of movement of the support member 66. When the handle 18 is swung in position from the position shown by FIG. 11 to the position shown by FIG. 10, the links 122, 124 are moved in the opposite direction. As they move, links 122, 124 exert a pushing force on the support member 92, moving it away from the standard 94. This also moves support member 66 away from the standard 94.

As shown by FIGS. 1-6, the thin wall clamping member 16 is provided with a resilient liner 136. An electrical heating element 138 is positioned between the clamping member 16 and the liner 136. Electrical wires 140 extend upwardly from below the base 12 and connect to the heating element 138, as shown by FIG. 6. A heat activated transfer 142 is positioned between the sidewall of the object 22 to be printed and the resilient liner 136.

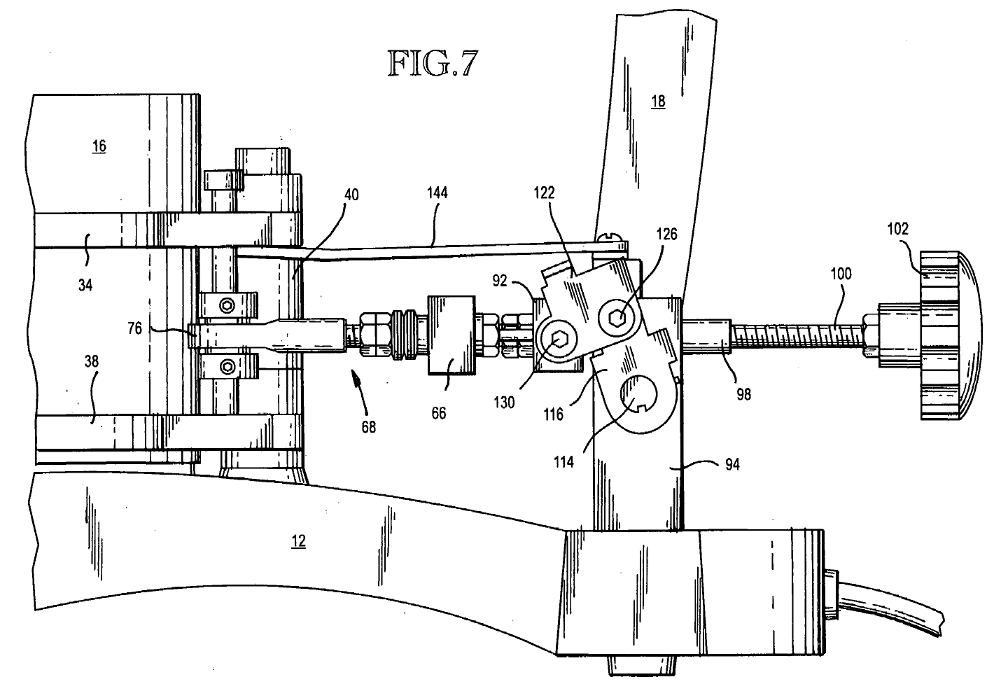

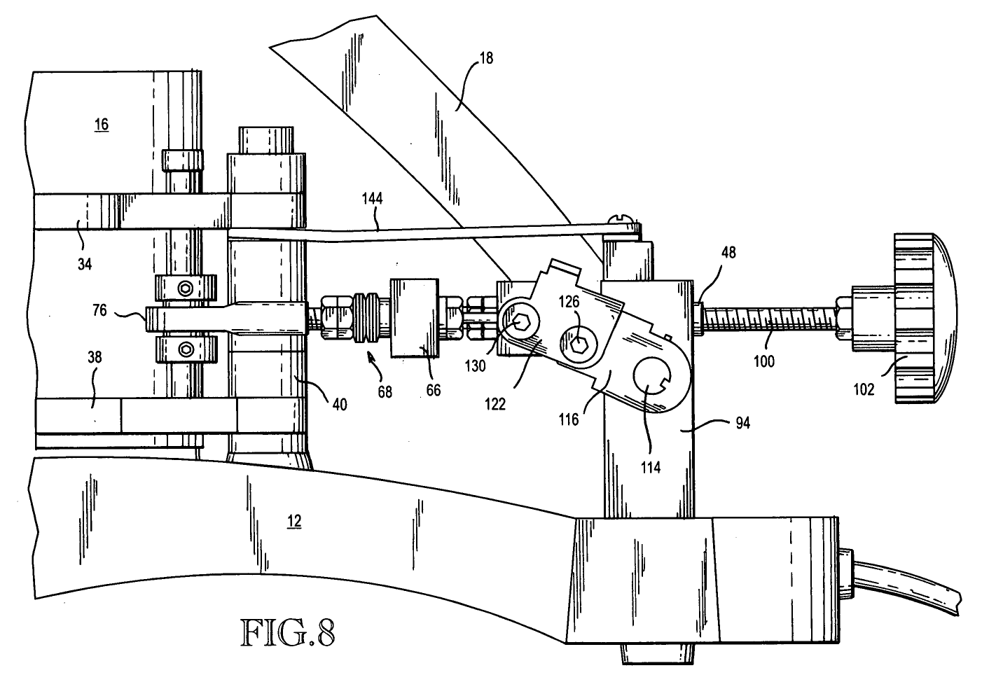

Prior to use, the control knob 106 is rotated to adjust the position of the screw 100 for initially setting the position of support member 66 relative to support member 92. This position takes into consideration the diameter of the object 22 and the combined thicknesses of the liner 136, the heating element 138 and the transfer 142. The screw is adjusted so that when the handle 18, 20 is down (FIGS. 4, 8 and 10) the object 22 and the transfer 142 are snuggly gripped by the clamping member 16 and its resilient liner 136. As can be seen from the above description of FIG. 12, a yielding resilient force is applied by the springs 88, 90. After the setting of the adjustment screw 100, the object 22 to receive printing and/or design, with the transfer 142 wrapped around it, are set down into the clamping member 16 when the handle 18, 20 is up (FIGS. 1-3, 7, 9 and 11). Then the handle 18, 20 is swung downwardly to contract the clamping member 16 and cause it to grip the object 22 and the transfer 142. If all of the objects 22 to be printed by the apparatus were the same, there would be no need for the adjustment provided by the adjustment screw 100 and the adjustable elements that it controls. The apparatus could be constructed to have a single setting and the only adjustment that would be necessary would be the adjustment provided by the springs 88, 90. However, the adjustment mechanism that includes the screw 100 is provided so that the apparatus can be used with objects 22 that vary in diameter to a certain extent.

The apparatus that has been illustrated and described is especially adapted for applying transfer indicia onto a cup that includes a handle 23. As clearly shown by FIGS. 1-4, when the cup 22 is held by the clamping member 16, the handle 23 is located in the space or gap that is between the ends of the clamping member 16.

The heat transfer process is not novel per se. When electrical energy is applied to the heating element layer 138, the heat causes the indicia on the transfer 142 to leave the transfer 142 and become adhered to the outer surface of the object 22. The heating system may include a thermostat 150 connected to the clamping member 16 and operable to control the temperature of the heating element by controlling electrical energy supplied to the heating element layer 138.

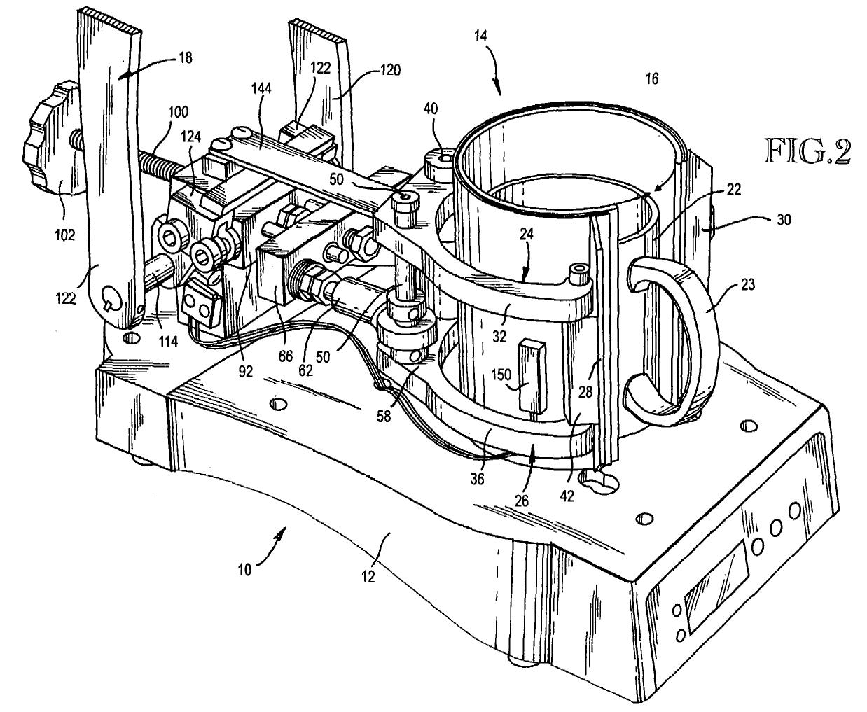

As shown by FIGS. 1 and 2, the links 122, 124 are in the form of yolks. They have spaced apart side portions interconnected by a top portion. The crank arms 116, 118 extend upwardly into a space between the side portions of the members 122, 124. When the crank arms 116, 118 and the links 122, 124 are in the position shown by FIG. 10, abutment surfaces 140 on the crank arms 116, 180 contact end portions 142 of the tops of the links 122, 124. This contact prevents further movement of the links 122, 124 towards the crank arms 116, 118.

As shown by FIGS. 1-4 and 7-9, a brace arm 144 may extend between a top portion of the standard 94 and the pivot post 146 that includes the pivot pin 40.

The illustrated embodiments are only examples of the present invention and, therefore, are non-limitive. It is to be understood that many changes in the particular structure, materials and features of the invention may be made without departing from the spirit and scope of the invention. Therefore, it is my intention that my patent rights not be limited by the particular embodiments that are illustrated and described herein, but rather is to be determined by the following claims, interpreted according to accepted doctrines of patent claim interpretation, including use of the doctrine of equivalents and reversal of parts.

What is claimed is:

1. A transfer printer for transferring printing from a transfer onto the outer surface of a generally cylindrical object, comprising:
a thin wall clamping member adapted to substantially surround the generally cylindrical object, said member having spaced opposite end portions;
push-pull elements connected to the opposite end portions of the clamping member, for moving said end portions towards and away from each other;
said clamping member having an inner surface; and
a heating element on the clamping member adjacent the inner surface,
whereby the generally cylindrical object to receive printing can be placed within the clamping member, with a heat activated transfer positioned between the clamping member and the outer surface of the generally cylindrical object, and then the opposite end portions of the clamping member can be moved relatively together to contract the clamping member and cause it to press the heat transfer against the outer surface of the generally cylindrical object, and wherein electrical energy can be applied to the heating element for heating the transfer and causing printing on the transfer to be transferred to the outer surface of the generally cylindrical object.

2. The transfer printer of claim 1, further comprising a resilient liner carried by the clamping member inwardly of the heating element, said resilient liner being adapted to contact the transfer that is in contact with the outer surface of the cylindrical object that is to receive printing.

3. The transfer printer of claim 1, wherein the opposite end portions of the clamping member form a gap between them, and wherein the end portions of the clamping member are provided with vertical stiffening members connected to the clamping member and the push-pull elements are connected to the stiffening members.

4. The transfer printer of claim 1, wherein the push-pull elements are arcuate members having first and second ends, wherein the first ends of the arcuate members are mounted for pivotal movement about an axis, and the second ends are connected to the end portions of the clamping member, and wherein said arcuate members curve as they extend from their first ends to their second ends and are spaced outwardly from the clamping member.

5. The transfer printer of claim 4, comprising first and second control arms, said arms having first ends connected to intermediate portions of the arcuate members, and are adapted to be retracted for swinging the second ends of the arcuate members apart, for pulling the end portions of the clamping member apart, and are adapted to be extended for swinging the arcuate members together, for pushing the end portions of the clamping member together and contracting the clamping member.

6. The transfer printer of claim 5, wherein the first and second control arms include compression springs, that are adapted to compress when the control arms are extended and expand when the control arms are retracted.

7. The transfer printer of claim 1, comprising first push-pull elements connected to the clamping member and second push-pull elements connected to the clamping member at a location spaced from the first push-pull elements.

8. The transfer printer of claim 7, wherein the push-pull elements are arcuate members having first and second ends, wherein the first ends of the arcuate members are mounted for pivotal movement about an axis, the second ends are connected to the end portions of the clamping member, and said arcuate members curve as they extend from their first ends to their second ends and are spaced outwardly from the clamping member.

9. The transfer printer of claim 8, comprising first and second control arms, said arms having first ends connected to intermediate portions of the arcuate members, and adapted to be retracted for swinging the second ends of the arcuate members apart and pulling the end portions of the clamping member apart, and adapted to be extended for swinging the arcuate members together, for pushing the end portions of the clamping member together, for contracting the clamping member.

10. The transfer printer of claim 1, wherein the printer is adapted to print on a cup that includes a handle, and the opposite end portions of the clamping member are spaced apart at least the width of the cup handle when the clamping member is contracted around the cup, and wherein said handle is positioned between the opposite ends of the clamping member.

11. The transfer printer of claim 1, comprising a handle having a first position and a second position and linkage between the handle and the push-pull elements, wherein the handle and linkage are adapted to extend the push-pull elements when the handle is swung from its first position to its second position, and to retract the push-pull elements when the handle is swung from its second position to its first position.

12. The transfer printer of claim 11, further comprising a resilient liner carried by the clamping member inwardly of the heating element, said resilient liner being adapted to contact the transfer that is in contact with the outer surface of the cylindrical object that is to receive printing.

13. The transfer printer of claim 11, wherein the opposite end portions of the clamping member form a gap between them, and wherein the end portions of the clamping member are provided with vertical stiffening members connected to the clamping member and the push-pull elements are connected to the stiffening member.

14. The transfer printer of claim 13, wherein the push-pull elements are arcuate members having first and second ends, wherein the first ends of the arcuate members are mounted for pivotal movement about an axis and the second ends are connected to the end portions of the clamping member, and wherein said arcuate members curve as they extend from their first ends to their second ends and are spaced outwardly from the clamping member.

15. The transfer printer of claim 13, comprising first and second control arms, said arms having first ends connected to intermediate portions of the arcuate members, and are adapted to be retracted for swinging the second hands of the arcuate members apart, for pulling the end portions of clamping member apart, and are adapted to be extended for swinging the arcuate members together, for pulling the end portions of the clamping members apart and contracting the clamping member.

16. The transfer printer of claim 15, wherein the first and second control arms include compression springs that are adapted to compress when the control arms are extended and expand when the control arms are retracted.

17. The transfer printer of claim 11, comprising first push-pull elements connected to the clamping member and second push-pull elements connected to the clamping member at a location spaced from the first push-pull elements.

18. The transfer printer of claim 1, comprising a rotatable shaft, a handle connected to the shaft, said handle being swingable from a first position into a second position for rotating the shaft, at least one crank extending radially from said shaft to an outer end, a slide member guided for back and forth linear sliding movement, a connecting link tubally connected at one end to the outer end of the crank and pivotally connected at its other end to the slide member, and a connector connecting the connecting member to the push-pull elements, wherein a swinging movement of the handle in a first direction will operate the crank and the connecting member to move the slide member and the push-pull elements for pushing the push-pull elements, and a swinging movement of the handle in the opposite direction will move the crank, the connecting member and the sliding member in the opposite direction for pulling the push-pull elements.
